(19) United States
(12) Patent Application Publication
(10) Pub. No.: US 2024/0215590 A1
(43) Pub. Date: Jul. 4, 2024

(54) PRODUCTION OF LEGUME-BASED NUTRIENT-DENSE DOUGHS AND FOOD PRODUCTS

(71) Applicant: Antithesis Foods Inc., Philadelphia, PA (US)

(72) Inventors: Ashton Yoon, Philadelphia, PA (US); Jason Goodman, Philadelphia, PA (US); Alexandra Hall, Philadelphia, PA (US)

(73) Assignee: Antithesis Foods Inc., Philadelphia, PA (US)

(21) Appl. No.: 18/608,783

(22) Filed: Mar. 18, 2024

Related U.S. Application Data
(63) Continuation of application No. 18/145,831, filed on Dec. 22, 2022.

(51) Int. Cl. A21D 2/26; A21D 2/36; A21D 8/02; A21D 10/00; A21D 13/045; A21D 13/06

(52) U.S. Cl. CPC A21D 2/266; A21D 2/362; A21D 8/02; A21D 10/002; A21D 13/045; A21D 13/06

(57) ABSTRACT

A system and method for the production of doughs and products using textured pulse proteins, including legume-based crunchy snack foods, said method comprising the steps of: homogenization of ingredients in the form of dry feed powders, mixing and hydration of powders with liquid ingredients to form a dough, forming of the dough into form factors, drying and expansion of the form factors to develop texture and shelf stability, and cooling.

### PRIORITY CLAIM

The present application is a Continuation of U.S. patent application Ser. No. 18/145,831 which claims the benefit of U.S. Provisional Patent Application Ser. No. 63/265,996 filed Dec. 23, 2021 and is incorporated by reference in its entirety as if fully set forth herein.

### STATEMENT REGARDING FEDERALLY SPONSORED RESEARCH OR DEVELOPMENT

This invention was made with U.S. government support under grant no. 1940271—SBIR Phase I, which was awarded by the National Science Foundation. The U.S. government has certain rights in the invention.

### FIELD OF INVENTION

The present invention relates to a system and method for making a food product and more particularly to a system and method for using textured pulse proteins in the production of legume-based nutrient-dense doughs and products thereof that achieve crunchy aerated textures, including crunchy snack foods. The present invention relates to making legume-based nutrient dense doughs and products thereof, including legume-based crunchy snack foods, that achieve aerated textures through the utilization of textured pulse proteins.

### BACKGROUND

Crunchy foods are typically made from starch-containing ingredients such as wheat, potato, rice, and corn flours. These confer a desirable flavor and texture but are low in nutritive value with low amounts of fiber and protein and high amounts of calories and net carbohydrates.

Legume-based crunchy foods struggle with producing the same texture as the traditional starch sources and are therefore often combined with commodity flours (e.g., wheat, potato, rice, and corn) to produce the necessary textures and palatability in the end product.

A legume is a plant in the family Fabaceae (or Leguminosae), or the fruit or seed of such a plant. When used as a dry grain, the seed is also called a pulse.

Well-known legumes include beans, soybeans, peas, chickpeas or garbanzo beans, peanuts, lentils, lupins, mesquite, carob, tamarind, alfalfa, and clover.

To enable broader utilization of legumes in the food industry, they are often processed and fractionated into flours, proteins, and fibers to allow them to be more easily incorporated during food processing unit operations while also making their nutrients more bioavailable.

The most common types of pulse proteins include protein concentrates (typically up to 70% protein by mass) and isolates (80%+ protein by mass).

Efforts to make plant-based and environmentally-friendly alternative meats that remain nutritionally dense led to a new category of textured proteins called textured pulse proteins (TPPs). These TPPs are typically comprised of pulse protein concentrates or isolates (often with other added ingredients such as pulse flours, wheat gluten, colorants, etc.) that are produced via a cooking extrusion system.

In the cooking extrusion system, the dry feed materials are hydrated with water. The high heat, pressure, and shear within the extruder barrel induces a series of physical and chemical transformations. As the dough exits the extruder barrel, the pressure drop at the die induces the superheated water to flash off as steam, thus causing expansion.

The die used can produce various shapes such as flakes, nuggets, chunks, strips, crisps, granules, cylinders, and more. A knife attached to the end of the extruder barrel cuts the dough and determines the length of each piece. The extruded pieces are then dried to a shelf stable water activity and moisture content.

The extrusion process of vegetable proteins changes the overall chemical structure in an effort to create fibrous textures that mimic the muscle tissues in meat. Changes to moisture, shear, pressure and temperature during the extrusion process can be used to create various structures and textures. In the process of creating these structures, the proteins undergo a series of conformational changes including denaturation, degradation, association, and aggregation. Additionally, carbohydrates are also subject to degradation and intermolecular interactions in the food matrix leading to overall conformational changes that impart unique physicochemical and functional properties that are not present in the protein concentrates/isolates alone.

When being used in meat analogue applications, the dried textured pulse proteins are rehydrated, allowing them to develop their animal meat-like texture. The rehydrated TPPs are then combined with ingredients such as flavorants (i.e. spices, sauces, flavors) to mimic the flavor of meat, fat to give mouthfeel and contribute to the flavor profile and browning reactions, as well as binders (i.e. starches, hydrocolloids, flours) to keep the matrix bound together. These plant-based meats can then be processed as traditional meats and used in various applications where they are pan seared, boiled, fried, baked, etc.

Commercially available crunchy legume-based food products do not currently utilize the unique functionality of textured pulse proteins and are thus texturally limited, have limited applications, or have other limitations such as restrictions in the amount of protein fortification or enrichments a food product can undergo before becoming sensorially unacceptable.

For the foregoing reasons, there is a need for a system and method for the production of legume-based nutrient-dense doughs and products thereof, including legume-based crunchy snack foods.

### SUMMARY

In view of the foregoing, it is an object of the present invention to provide a system and method for the production of legume-based nutrient-dense doughs and products thereof, including legume-based crunchy snack foods, that satisfies existing needs. An embodiment of the present invention thus provides:

A system and method for the production of legume-based nutrient-dense doughs and products thereof, including legume-based crunchy snack foods, said method comprising the steps of: milling of textured pulse proteins into a powder, homogenization of dry feed powders, mixing and hydration of powders with liquid ingredients to form a dough, forming of the dough into form factors, drying and expansion of the form factors to develop texture and shelf stability, and cooling. After cooling the resultant product has a crunchy aerated matrix. Additional steps may include the application of topical seasonings and coatings, pulverization of the crunchy products to produce crumbles for other downstream applications, incorporation into other food products, as well as packaging steps using food safe packaging that maintain freshness and the structural integrity of the product.

A novel feature of this invention is the unconventional processing of textured pulse proteins into a powder and their subsequent incorporation into the dough formulation. This ingredient addition contributes unique functionalities to the dough such as greater gas holding capacity, elasticity, and enhanced viscoelastic properties. Novel features of the present invention will be further described in detail in the description and the accompanying claims. The present invention itself, and other objects and advantages of the present invention will be readily understood from the description below.

The invention can be used to commercially produce legume-based finished ingredients and snack foods that exhibit a similar neutral flavor and appealing texture as products based on commodity crops such as wheat, rice, potato, and corn. Additionally, these products can be enriched to be much more nutrient dense, with elevated levels of protein and fiber while maintaining comparable organoleptic properties. This has potential for application in traditionally starch-based expanded product and baked goods such as chips, cookies, crackers, muffins, breads and more. Additionally, this invention can be used to create inclusions/onlusions that can replace the nuts, chocolate pieces, pretzels, toffee pieces, dried fruit, flavored sugar/candies, cereal, cookie pieces, etc. that are typically used.

Additionally, the invention can be utilized to develop highly functional upstream ingredients. In the steps described above, the milled textured pulse protein can be utilized as a protein concentrate or isolate to impart lighter and more aerated textures into foods. At the dry blend stage, the textured proteins are homogenized with other dry powders to create blends that can serve as ingredients, such as a gluten-free flour blend, or finished mixes, such as a baking mix.

The textured pulse protein can be milled by a variety of types of milling equipment, including but not limited to hammer, jet, colloid, corundum, air classifier, ball, and pin mills as well as crushers, shredders, and granulators.

Although a very narrow claim or set of claims is presented herein, it should be recognized the scope of this invention is much broader than presented by the claims. It is intended that broader claims will be submitted in an application that claims the benefit of priority from this application.

### BRIEF DESCRIPTION OF THE DRAWINGS

These and other features, aspects, and advantages of the present invention will become better understood with regard to the following description, appended claims, and accompanying drawings, where:

FIG. 1 shows a flowchart indicating the processing steps for the utilization of textured pulse protein in legume-based nutrient-dense doughs in the production of crunchy snack foods in an embodiment of the present invention;

FIGS. 2A-E show various form factors of legume-based nutrient-dense doughs in the production of crunchy snack foods in an embodiment of the present invention;

FIG. 3 shows an SEM micrograph of a cross- sectioned ball form factor of a crunchy snack food product of a version of the present invention showing extensive network formation and high volume of air cells; and

FIG. 4 shows a graph of the expansion ratio, hardness, crispness, and crunchiness of balls of crunchy snack food products of a version of the present invention produced by commercial convection (control) and three formulations under vacuum microwave drying (VMD), with error bars reflecting variability within each sample.

### DESCRIPTION

In the Summary above, and in the Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or which comprises”) components A, B, and C can consist of (i.e., contain only) components A, B, and C, or can contain not only components A, B, and C but also one or more other components.

Where reference is made herein to a method comprising two or more steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1.

The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, “25 to 100 mm” means a range whose lower limit is 25 mm and whose upper limit is 100 mm.

Nutrient-dense foods are those that are high in nutrients but relatively low in calories. Such foods contain complex carbohydrates, lean protein, healthy fats, vitamins, and minerals.

Examples of nutrient-dense foods include fruits, vegetables, lean meats, whole grains, low-fat or fat-free dairy products, seafood, eggs, peas, beans, and nuts.

Commercially available crunchy legume-based food products fall into three main categories: 1) dehydrated whole legumes; 2) expanded snacks made with legume flours; and 3) thin sheets made with legume flours.

Dehydrated whole legumes are texturally limited due to the legume (e.g., chickpea) being primarily in its native form, with the dehydrated whole legume adopting a crumbly and chalky texture. Additionally due to its appearance as a legume, its applications are limited and ability to enrich with nutritionally dense macronutrient components is nonexistent.

Expanded legume snacks are typically produced via cooking extrusion or compression popping and have a lighter texture, but due to the mechanism of expansion in extruded and compression popped products, this requires a high amount of amylopectin starch, of which legumes contain less of in comparison to other starchy ingredients like wheat, potato, rice, and corn. Therefore legume-based expanded snacks often include high amounts of another type of flour.

Sheeting and cold extrusion are often used to create thin sheets of legume doughs to make products such as chips and crackers, which are usually fried or baked to dry out the dough and develop crunchy and crispy textures. Frying adds a significant amount of fat to the product and the high temperatures inhibit utilization of high amounts of protein, as this component is sensitive to browning. While baking methods will not contribute extra fat and can more easily protect against extensive browning reactions, nutritionally enhanced doughs suffer from poor textural qualities such as hardness and brittleness due to their lack of expansion properties and concomitant lack of textural complexity.

A novel method is described herein for structuring legume flours, fibers, and proteins into a crunchy, aerated matrix that sensorially competes with commercial products based on commodities such as wheat, potato, rice, and corn, but provides much higher nutritional value. This novel method can also be used to create aerated matrices and improve sensory attributes across food categories, including but not limited to foods with crunchy, crispy, soft, creamy, chewy, and firm textures. An aerated matrix in foods can be described as a structure in which air cells and a porous structure are present as a result of incorporation of air, phase transition of water into steam, and/or the generation of gas through chemical reactions during processing. The invention can be used to make finished goods with these textural attributes, or dry blends that are later converted into finished food products.

Crunchiness is used to describe foods that break into pieces when chewed with enough force. These pieces do not dissolve in the mouth and must undergo further chewing to masticate into sizes small enough to swallow. Crunchy foods typically break into pieces when initially chewed with enough force, and the pieces must often be subjected to further chewing to masticate into sizes small enough to swallow. Such foods require more mechanical strength to chew, are more rigid in structure, and make a more audible sound when chewed when compared to crispy foods. Examples of crunchy foods include pretzels, tortilla chips, crackers, croutons, and ridged potato chips.

Though a singular food may possess textural aspects of both crunchiness and crispness, crispy foods break into very small pieces or dissolve in the mouth easily when chewed with minimal force. They are characterized by an incremental and progressive fracture that creates a series of audible sounds with lower acoustic output than crunchy foods. Examples of crispy foods include cheese puffs, classic potato chips, popcorn, puffed rice cereal, and veggie straw chips.

The present invention can be incorporated as an ingredient in crispy food formulations to improve the texture. Foods are perceived as crispy due to their fracture properties. Textured pulse proteins enhance the viscoelasticity and gelling behavior of doughs and improve air cell formation in expanded foods, reducing the fracture stress of the product and increasing the perception of crispy textural sensations. During extrusion, proteins undergo extensive conformational changes that influence their physicochemical and functional properties—they are denatured, exposing amino acids that can associate, aggregate, and cross-link, thus changing their three-dimensional structure. Additionally, primary structure can be changed through degradation of the molecular chains. These conformational changes in turn alter the covalent and noncovalent linkages that form within and between the polypeptide chains, further influencing the protein's structure and overall behavior which is observed in changes to water and oil absorption capacity, gelling capacity/water holding capacity, emulsification, and solubility. Protein-polysaccharide conjugates are also formed during the processing of textured pulse proteins that further affect the physicochemical properties. As the melt exits the extruder barrel, the proteins are aligned in the direction of extrusion, rearranging and crosslinking, thus creating the fibrous texture. When milled into a powder, the textured pulse proteins exhibit many of these changed functional properties. Additionally, the process of milling can induce mechanochemical changes to the various components of textured pulse proteins, including starch degradation and protein denaturation, that further influence its behavior properties. Enhanced affinity for water and emulsification properties can be attributed to the disruption of the three-dimensional structure and different distribution of the hydrophobic and hydrophilic amino acid on the exterior of the protein.

Crispness and crunchiness could each be assessed on a variety of characteristics, such as on the basis of sound, oral-tactile clues or a combination thereof, on the basis of sensory testing through consumer acceptance testing or descriptive analysis, or on the basis of texture property measurement with a texture analyzer.

For the purpose of the following descriptions, certain products of embodiments of the invention are described as “crunchy” as this is the predominating textural aspect. However, certain products of the invention also possess elements of crispness as these two textures (i.e., crunchiness and crispness) are not mutually exclusive. It is understood that embodiments of the invention may possess qualities and textures other than, or in addition to, crunchiness or crispness.

For example, soft foods such as breads, cookies, brownies, muffins, baked goods, and variations thereof, creamy foods such as porridges and sauces, and chewy foods such as pastas and bars. In soft foods, textured pulse proteins improve air cell formation, moisture retention, and elasticity through enhancing the water absorption capacity and viscoelastic network of the dough or batter. The enhanced viscoelastic properties are attributed to the increase in disulfide bonding within and between polypeptide chains. In creamy foods, textured proteins enhance viscosity through enhanced protein-protein and protein-water interactions and thus increase sensory perception of smoothness and thickness. In chewy foods, textured proteins increase the amount of mastication needed to form a bolus by binding water and holding it within the matrix. In all applications, the application of the invention provides protein fortification or enrichment. Additionally, by enhancing the textures of foods for the aforementioned applications, this enables further nutrient fortification while maintaining appropriate organoleptic properties expected by consumers.

A novel dough formulation is combined with drying technology to create a customizable legume-based platform for producing a nutritionally dense ingredient portfolio with broad application in processed foods. A unique combination of formulation and process produces a crunchy texture from a legume-based dough (e.g., a chickpea-based dough). The novelty of the dough is due to several factors, described herein.

First, textured pulse protein contributes to the development of the aerated structure. Textured pulse proteins are extruded products that utilize various types of pulse protein (often with some added legume flours, wheat gluten, and/or colorants as additional components that comprise the base formulations) as the feed ingredient. Utilization of these proteins is typically used in the development of plant-based meat analogues. The extrusion process serves to functionalize the proteins, causing denaturation and realignment in the direction of extrusion, alongside complex conformational changes and molecular interactions between protein, carbohydrate, and lipid. These changes lead to elevated water binding capacity, viscosity, and pasting properties which influence dough rheology and account for its functional properties including enhances gas holding capacity, elasticity and viscoelastic properties.

Typically, textured pulse proteins are extruded into various shapes and sizes to mimic different types of meat products (ground, strip, chunk, nuggets, etc.), which are later hydrated to form different types of plant-based meat products. Instead of using them in this manner, the present invention involves using ground textured pulse proteins that make a fine powder and incorporating them as a dry feed ingredient into dough formulations. The novel use of this ingredient influences dough rheology and enhances expansion in the final cooked product through its water binding, viscosity, and pasting properties.

This use of textured pulse proteins allows the current invention to have an enhanced dough with elevated levels of protein and fiber far beyond what would normally be organoleptically acceptable with traditional legume-based flours. Enrichment or fortification of food products with nutrient dense components including protein and fiber are typically known for inferior texture. The current invention allows for the development of acceptable textures with high levels of nutrient density.

When used as a powdered protein concentrate or isolate, textured pulse proteins can be incorporated into food formulations to enhance the nutritional density while maintaining acceptable sensory properties. When used in place of traditional flours, starches, and proteins, textured proteins can mimic many of the functional properties of these traditional ingredients. In addition, textured pulse proteins confer some key manufacturing advantages. They can be used to replace the function of other commonly used food additives, such as leaveners (baking powder, baking soda, cream of tartar), gelling agents (hydrocolloids, agar, gelation), and starches (tapioca, potato, corn), thus enabling the production of cleaner label food products with an enhanced nutritional profile. Additionally, the enhanced viscoelasticity of the dough enables doughs produced with textured pulse proteins to be manufactured more readily on traditional gluten-based dough lines in comparison to gluten-free doughs without textured pulse proteins.

Another factor is the inclusion of other functional ingredients in the form of hydrocolloids such as xanthan gum. Hydrocolloids, when combined with textured pulse proteins, create a strong viscoelastic mass capable of expansion.

The network formed using textured pulse proteins helps build a more extensible network based on the structural modifications induced by the high shear, heat, and pressures of extrusion. The dough does not rely on typically used chemical and biological leaveners, such as sodium bicarbonate or yeast. The expansion and development of texture is induced by the phase transition of water only. The viscoelastic mass is flexible enough to expand, yet strong enough to hold the structure together, thus demonstrating properties similar to gluten. As water vaporizes, the viscoelastic structure traps the water vapor, forming air pockets and developing an interior porosity similar to leavened bread.

Although it is not necessary to add chemical and/or biological leavening agents to produce acceptable textures, they can also assist to enhance expansion and texture in some applications of this invention.

After being milled or ground into a powder, textured pulse proteins function similar to starch in doughs, while also increasing the protein density of finished snack foods compared to starch alone. Even when added at low percentages, the textured pulse proteins have expansion-promoting effects that enhance texture and acceptability. Similar to the benefits that textured proteins confer in finished food products as described above, they confer the same advantages in dry mixes that are due for later conversion into finished food products. When sold as a protein powder or included in a dry powder mix, textured pulse proteins enhance the nutritional profile through fortification/enrichment with protein, fiber, and complex carbohydrates, serve as additive replacements for gelling agents, hydrocolloids, and leaveners, and enable greater ease of producing gluten-free products due to the enhanced dough elasticity.

Different types of TPPs have different in product efficacies. The functional properties of TPPs may be affected by factors such as the raw materials (i.e. legume type, pre-processing or pretreatment, composition, particle size, protein content), extruder (extruder type, screw configuration, die shape and length), extrusion processing parameters (barrel temperature, screw speed, moisture content, injected liquid temperature, feed rate), extrusion response parameters (pressure, specific mechanical energy, shear, torque) and milling or grinding method (i.e. equipment used, temperature, particle size, mesh size). Intermolecular interactions between protein molecules as well as protein-starch, protein-lipid, and starch-lipid interactions impact TPP structure.

These variables present from the production of raw materials to TPP to ground TPP all affect the final functional properties of the TPP powder and its behavior in dough, including, but not limited to, water absorption capacity, water holding capacity, water absorption index, water solubility index, emulsifying properties, product density, degree of texturization, nitrogen solubility index, oil absorption capacity, oil emulsification capacity, degree of starch gelatinization, degree of expansion, gelation, gel strength and syneresis, foaming, rheology, breaking, penetration and crushing force, hardness and breaking strength, rehydration rate, adhesiveness, tensile strength, film-forming properties, extensibility, and pasting properties. These in turn may also affect the behavior of the ground TPP in the dough matrix, and the final product texture.

The TPPs are typically homogenized with the other dry ingredients prior to addition of liquid ingredients but can also be incorporated at other stages of the dough-making process. For instance, it is also possible to mix the TPPs with the liquids separate from the other dry ingredients, or extruding the dry feed, including TPP, which would accomplish mixing, hydrating, and cooking steps all at once. Also, various levels of fats, water, and other ingredients affecting dough hydration and rheology are added to the formulation depending on the manufacturing equipment used as well as the desired final product texture.

Fats that could be used include oils such as canola, rapeseed, sunflower, safflower, vegetable, olive, extra virgin olive, coconut, avocado, palm, or soybean oils. Other fats that could be used include butter, animal fats, and other hydrogenated or partially hydrogenated oils.

Typically, addition of nutrient dense macronutrient components such as protein and fiber to crunchy foods result in reduction of expansion and dense and brittle final products. In embodiments of the present invention, protein (along with hydrocolloids and moisture) serves to enhance expansion in lieu of hindering. Varying the levels of textured proteins along with hydrocolloids and moisture can compensate for any densifying effects from other proteins, fibers, etc. added to the dough for nutritional enhancement.

Also, the dough can be dried to produce a desirable texture using multiple different drying processes when processing parameters such as temperature, humidity, air flow, residence time, etc. are properly controlled. Various combinations of these parameters impart different degrees of expansion and textural properties. This allows for flexibility and great opportunity to maximize throughput for scaled production.

Specific formulations are combined with downstream drying technologies to impart an array of textures. From this, an ingredient platform is developed containing neutral tasting crunchy ingredients in a broad variety of shapes, textures, and macronutrient profiles to fit many crunchy applications.

For the preparation of crunchy products, the formulation is where most of the nutritional profile and texture are determined. Formulations are comprised of legume flours, soluble and/or insoluble fibers, legume proteins, starches, hydrocolloids, and salt.

The specific raw ingredients selected for these base components are used to customize for specific needs including shape, textures, nutritional profile, product claims (e.g., non-GMO, allergen-free, Kosher, clean label), and downstream physiological effects (e.g., prebiotics, satiety, glycemic index, protein quality).

Flour made from legumes/pulses is a main ingredient in a legume-based crunchy snack. Pulse flour is made by grinding or milling whole pulses into flour. Commercially available pulse flours include chickpea, lentil, pea, fava, mung bean, and lupin.

While all pulse flours are low in fat, there are some significant differences among them regarding protein, carbohydrate, fiber, and micronutrient content. Pulse flours have higher levels of micronutrients such as folate and iron.

Other commercial products on the market that use pulse proteins have limitations nutritionally and/or sensorially.

On a mass basis, pulse flours typically contain over double the amount of protein (>20%) compared to traditionally used flours ie. rice, corn, wheat, and potato (<10%). Thus, legume flours are often used to add additional protein, but often possess inferior texture due to lower overall levels of starch as well as lower amylopectin and higher levels of amylose than traditionally used flours.

Inferior texture in legume flour fortified snack foods limits the amount of protein that can be added though this method. The addition of textured pulse proteins via this invention offers a solution to enhance protein beyond what is possible with flours without compromising on texture.

There are several commercial approaches that have tried to make better-for-you processed foods. However, inferior texture in legume based and legume flour fortified snack foods limits the application and amount of protein that can be added though previous commercial approaches. These approaches typically fall into two main categories—1) cooked and dehydrated whole legumes and 2) extruded or compression popped expanded snacks made with legume flours.

Cooked and dehydrated whole legume snacks are minimally processed, but their application is limited to the form factor of the whole legume. Additionally, the flavor is largely unchanged so legume off-flavors remain in the final product and the dehydrated whole legume adopts a crumbly and chalky texture.

Extruded or compression popped expanded snacks made with legume flours have better textures than whole legumes but rely on the addition of starchy ingredients like wheat, potato, rice, and corn to achieve light and aerated textures. Therefore, legume-based expanded snacks often include high amounts of another type of flour, which are much less nutritionally dense than legumes and pose additional allergen risks.

The addition of textured pulse proteins via this invention offer a solution to enhance protein beyond what is possible with flours without compromising on texture. The products created with this invention differ from those currently sold at national retail outlets in that they are designed to look, taste, and crunch like junk food products (chips, candies, crackers and cookies). Although the current invention and presented embodiments involve solely crunchy and crispy applications, this invention can also be applied to any dough-based food products such as pizza crusts, muffins, breads, tortillas, soft baked cookies, and other baked goods. In processed food production, many foods are made from various types of doughs and batters, including ones that are baked, extruded, or frozen. These doughs can be used to make foods with textures such as crunchy, crispy, soft, creamy, chewy, and firm. Textured pulse proteins can be applied in these types of foods for enhanced nutrition and functionality, at all stages throughout the supply chain—included as a protein powder, in a dry powder mix, and finally into a finished food product.

Embodiments of the present invention utilize legume flours that have been pre-processed in different manners to achieve various in-dough functionalities and end product properties.

Examples of these include chickpea flours that may come from uncooked and unhulled dry chickpeas, par-cooked and dried chickpeas, and fully cooked and dried chickpeas.

In some embodiments, various ingredients such as umami ingredients, seasonings, natural flavors, and sweeteners are added to modify the flavor profile for targeted sweet and savory applications. Controlled Maillard browning is utilized to impart certain brown flavor notes.

Protein, in the form of chickpea, pea, lentil, fava, mung bean, soy, or other legume proteins, is an additional ingredient.

In some embodiments, soluble or insoluble fibers are added. These can be from sources such as chicory root, artichoke, oat, corn, potato, tapioca, or other soluble or insoluble fiber sources.

Another one of the ingredients that helps create the texture of a legume-based crunchy snack is a hydrocolloid (e.g., xanthan gum, guar gum, gum arabic, locust bean gum). Hydrocolloids are functional carbohydrates used in many foods to enhance their shelf life and quality. These additives are also used to modify the viscosity and texture of food products.

Another one of the ingredients that helps create the texture of a legume-based crunchy snack is starch. Amylose and amylopectin are the two polysaccharides present in starch. Amylopectin is a branch-chained polysaccharide, whereas the other component of most starches, amylose, is a straight-chained polysaccharide.

Waxy starches enhance the texture of foods due to their high amylopectin content that, for example, confers advantageous gelling and pasting properties that confer a gluten-like texture to the dough in embodiments of the present invention, allowing it to stretch and expand.

While the amylopectin in waxy starch assists in elasticity and expansion, amylose is the component of starch that enhances crispness due to the linear nature of its structure.

The starches used in embodiments of the present invention may be waxy corn starch or waxy potato starch. While normal corn starch typically has a ratio of about 25% amylose to about 75% amylopectin, waxy corn starch contains about 100% amylopectin. While normal potato starch typically has a ratio of about 20% amylose to about 80% amylopectin, waxy potato starch contains about 100% amylopectin. The waxy starch used in embodiments of the present invention preferably contains about 100% amylopectin starch and about 0% amylose starch.

The waxy texture of the amylopectin starch used in embodiments of the present invention contributes to the final product characteristic texture and other properties. Crispness is greatly enhanced with starch addition. Crunchiness is impacted by the addition of starch as well. Hardness, the peak force exerted during chewing, is reduced by the addition of waxy starches. These are all indicators of improved texture, as lower hardness and higher crispness in particular have been shown to be correlated with higher quality expanded snacks.

In some embodiments, native pea starch is utilized to impart a crispy texture.

While amylopectin assists in elasticity and expansion, amylose is the component of starch that enhances crispness due to the linear nature of its structure. Amylose content of pea starch is high, typically around 35%, contrasting with waxy starches that typically contain <1%.

The utilization of functional proteins and hydrocolloids facilitates the development of a gluten-like structure capable of expansion. That is, textured pulse proteins and hydrocolloids are the functional ingredients that allow for the creation of aerated textures in a dough matrix with elevated fiber and protein.

Elevated levels of hydrocolloids are utilized which forms a gel when hydrated, enhancing the viscoelasticity of the dough.

In some commercial applications, textured pulse proteins are typically hydrated and compressed to recreate the striated texture of animal meat, and hydrocolloids are typically used in concentrations of under 0.5% of the wet mass in dough-based applications. This process achieves the goal of mimicking animal meat textures. The current invention aims instead to recreate the functionality of gluten in snack doughs, and thus combines these ingredients in an different and unconventional way.

The embodiments of the present invention utilize textured pulse proteins that are ground and dispersed throughout the dry feed formulation and hydrocolloids used in concentrations up to 15% of the dry mass, representing approximately up to ten times the conventionally suggested usage levels. The higher usage of hydrocolloids in combination with the powdered textured pulse proteins work synergistically in the dough to further promote a gluten-like functionality and texture to the final embodiments.

Another ingredient that is utilized is salt (e.g., sodium chloride). This ingredient accounts for up to 6% of the mass of the dry ingredients.

Table 1, below, shows approximate ranges of concentrations of ingredients in embodiments of the invention.

TABLE 1
Approximate Ranges of Concentrations of Ingredients

| | Percentage range |
|---|---|
| Ingredients | (%) (dry basis) |
| Legume flour | 0-75 |
| Fiber powder (soluble, insoluble, or combination of | 1-75 |
| both) | |
| Textured pulse protein | 0.2-95 |
| Legume proteins | 0-55 |
| Starch | 0-10 |
| Hydrocolloid (e.g., Xanthan Gum) | 0-15 |
| Salt (e.g., sodium chloride) | 0-6 |
| Oil | 0.1-40 |

Table 2, below, shows approximate ranges of concentrations of ingredients in embodiments of the invention.

TABLE 2
Approximate Ranges of Concentrations of Ingredients

| | Percentage range |
|---|---|
| Ingredients | (%) (dry basis) |
| Legume flour | 0-75 |
| Fiber powder (soluble, insoluble, or combination of | 1-75 |
| both) | |
| Textured pulse protein | 0.2-95 |
| Legume proteins | 0-55 |
| Starch | 0-10 |
| Fruit-derived powders (e.g. cocoa, strawberry) | 0-45 |
| Tea powders (e.g. matcha) | 0-20 |
| Citrus juices (e.g. lemon juice) | 0-5 |
| Acidulants | 0-5 |
| Spices & herbs | 0-5 |
| Leaveners (e.g biological, chemical) | 0-2.5 |
| Sweetener powders (e.g. natural, artificial) | 0-35 |
| Sweetener syrups (e.g. tapioca, honey, allulose) | 0-35 |
| Humectants (e.g. glycerin, invert sugar, molasses) | 0-35 |
| Hydrocolloid (e.g., xanthan Gum) | 0-15 |
| Flavors (artificial, natural) | 0-5 |
| Flavor extracts | 0-5 |
| Salt (e.g., sodium chloride) | 0-6 |
| Emulsifiers (e.g. eggs, lecithin) | 0-5 |
| Fat (e.g., oils, modified oils, butter) | 0.1-40 |
| Inclusions (e.g. nuts, dried fruits, chocolate chips, | 0-25 |
| confectionery pieces) | |
| Seasonings | 0-30 |
| Protein powders (e.g. egg, whey, hemp) | 0-45 |
| Non-legume flours (e.g. quinoa, almond, oat) | 0-75 |
| Grain powders (e.g. barley) | 0-75 |

Solid dry ingredients, in powder form (powders), are mixed together to obtain a homogeneous mixture.

The dry ingredients are combined and mixed with liquid ingredients (e.g., water, oil) to hydrate the dry ingredients and form a dough.

An additional variable that affects final product texture is dough moisture content. Since water vapor contributes to expansion, water or moisture content is used to adjust the amount of expansion in the crunchy products.

Moisture content is therefore used as an additional variable by which to control expansion and develop texture, with lower moisture content yielding a denser and crunchier product, and higher moisture content yielding increased aeration and crispness. Typical moisture contents for dough in embodiments of the present invention range from 10-65%.

Lastly, in some embodiments the dough is dried to produce a desirable texture using multiple different thermal and nonthermal drying processes. Control of processing variables determine the rapidity and degree of expansion due to water vaporization, allowing for the development of the internal structure and final product texture.

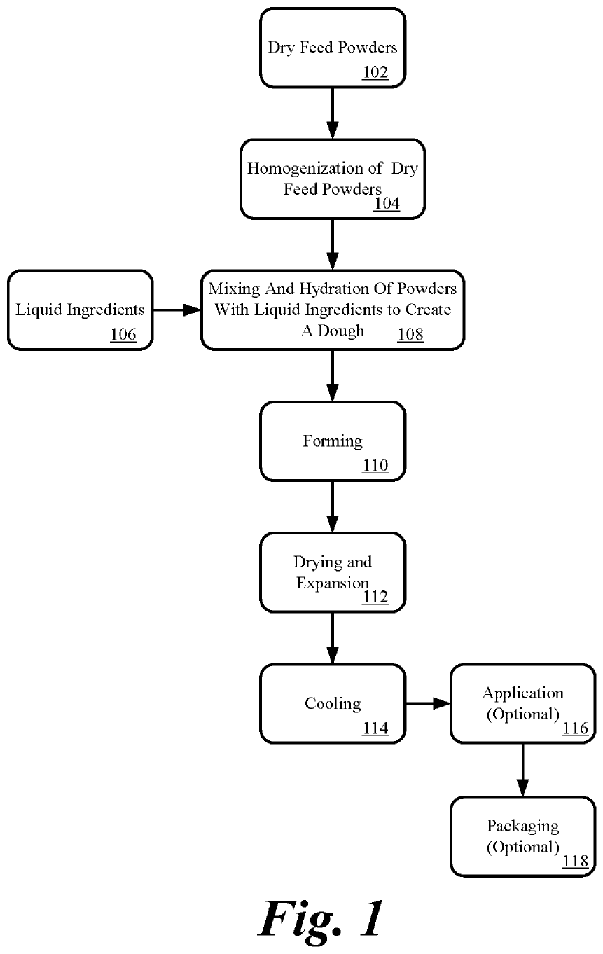

With reference to FIG. 1, therein is depicted a flowchart indicating the general processing steps of one embodiment of the present invention for producing legume-based nutrient-dense doughs and products thereof, including legume-based crunchy snack foods.

The general unit operations involved consist of several steps. In the first processing step, the dry ingredients for a dough (i.e., legume flour, fiber powder, textured pulse protein, food starch, hydrocolloid, and salt), in the form of dry feed powders 102 undergo homogenization 104.

Homogenization 104 is achieved by processing the powders with the use of a homogenizing mixer or other device to achieve a generally even distribution of the diverse dry powder ingredient components. In one embodiment, powders are homogenized in a homogenizing mixer at 95 rpm for 1.5 minutes.

In the second processing step, liquid ingredients 106 (e.g., water, oil) are mixed with the powders 102, resulting in, among other things, hydration of the powders 102. One embodiment involves the rapid addition of water and mixing at 225 rpm for 2 minutes to prevent preferential hydration of ingredients with high water binding capacity (and thus allow all ingredients to exhibit their functional properties). In another embodiment, a planetary mixer affixed with paddle attachment is used at speed 4 when liquid ingredients are added.

Mixing and hydration 108 occurs in a continuous, batch, or other mixer to form a dough (not shown). In one embodiment, a planetary mixer affixed with paddle attachment is used to mix and hydrate the dough at speed 3 for 3-5 minutes.

In one embodiment, dough is prepared utilizing a planetary mixer with paddle attachment. (This procedure has been optimized to prevent the agglomeration that is common in gluten-free dough formulations that contain multiple ingredients with high affinity for water.) The dough finishes mixing at 135 rpm for 2.5 minutes. Doughs are rested and tempered at room temperature (e.g., approximately 23 C) or refrigerated temperatures (e.g., approximately 3-5 C) prior to forming and thermal treatment.

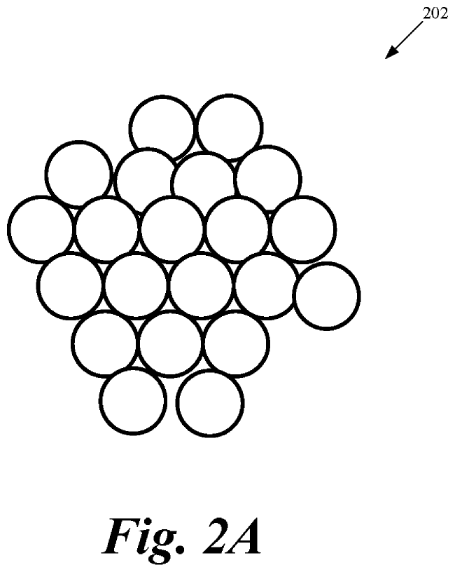

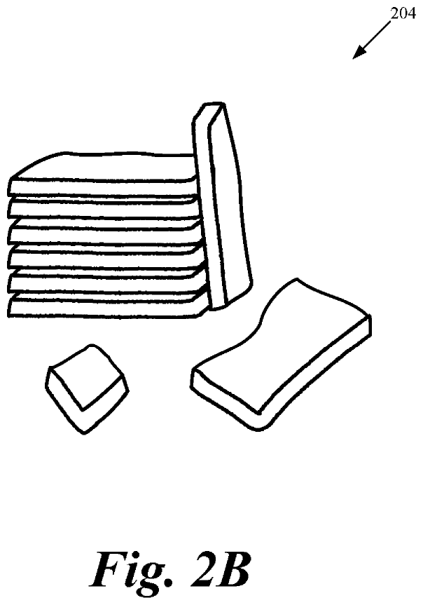

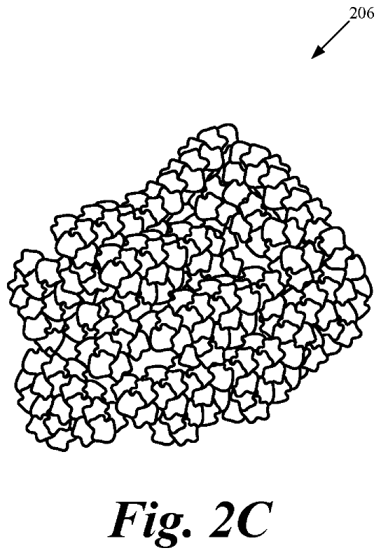

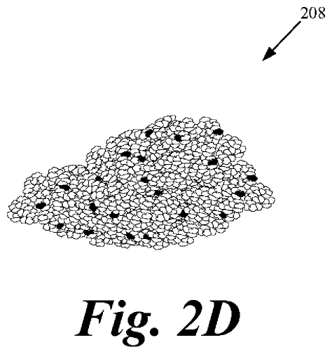

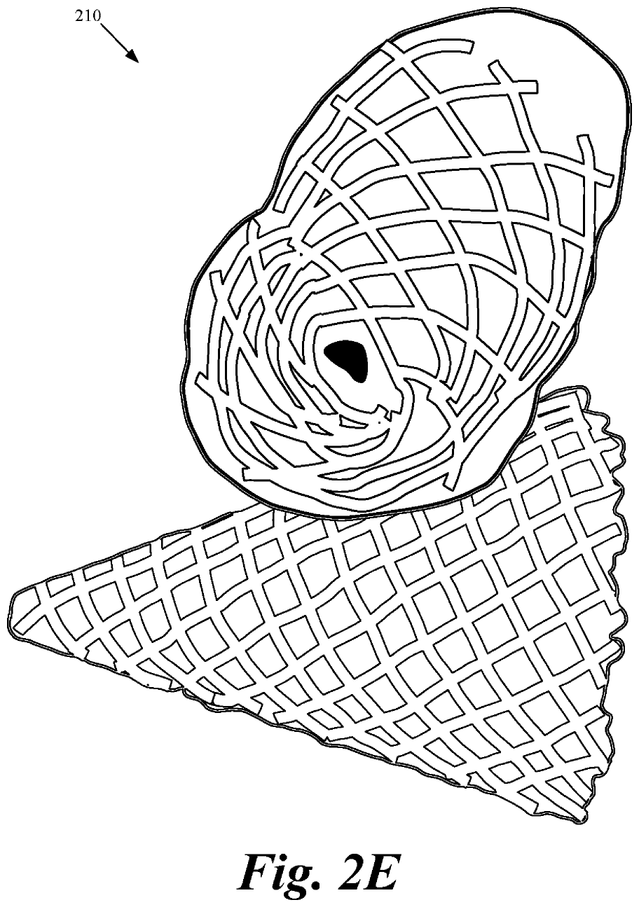

The dough then undergoes a forming step 110, whereby the dough is formed into one or more form factors such as, but not limited to, balls 202, sheets 204, flakes 206, croutons 208, and cones 210 (see FIGS. 2A-2E). Balls 202 are spherical structures, sheets 204 are roughly rectangular-shaped flat structures, flakes 206 are irregular, roughly elliptical-shaped flat structures, croutons 208 are irregular granular structures, and cones 210 are conical structures. The forming step 110 involves cold extrusion, sheeting, or other forming methods.

The forming step is completed by equipment such as cold extruders or sheeters.

The form factors (balls 202, sheets 204, flakes 206, croutons 208, and cones 210) then undergo a drying and expansion step 112 to develop texture and shelf stability.

Drying and expansion 112 can be achieved in various ways, including, but not limited to convection drying (combination, tunnel/band oven, drum) or vacuum microwave drying (VMD).

Convection drying is a process in which hot air is circulated to induce the heating of a material. The subsequent phase transition of water from a liquid to vapor is carried off by the air as humidity.

Microwave vacuum drying is a drying process that uses a combination of vacuum and electromagnetic radiation. Vacuum in the chamber reduces the vapor pressure difference between the water in the food and the surrounding air, thus allowing water to vaporize faster and at a lower temperature than at atmospheric pressure. This reduces the boiling temperature of water. The introduction of electromagnetic waves into the chamber generates kinetic energy and heat through the movement of water. Water quickly boils at the lowered boiling temperature and moisture is wicked away from the food, enabling rapid drying and expansion.

Combination drying, or combi drying, uses convection, steam, or a combination of both. Combi dryers can quickly and accurately regulate their internal climate temperature and humidity. Although combi drying relies on convective heat transfer like convection ovens, the ability to control humidity is key in accelerating drying. Combi ovens can create virtually any climate and can replicate the conditions of most industrial drying processes. Tunnel ovens, band ovens, drum driers, dehydrators, and air driers are scaled methods that all rely on various combinations of temperature and humidity. Factors such as air flow and product agitation may differ between methods.

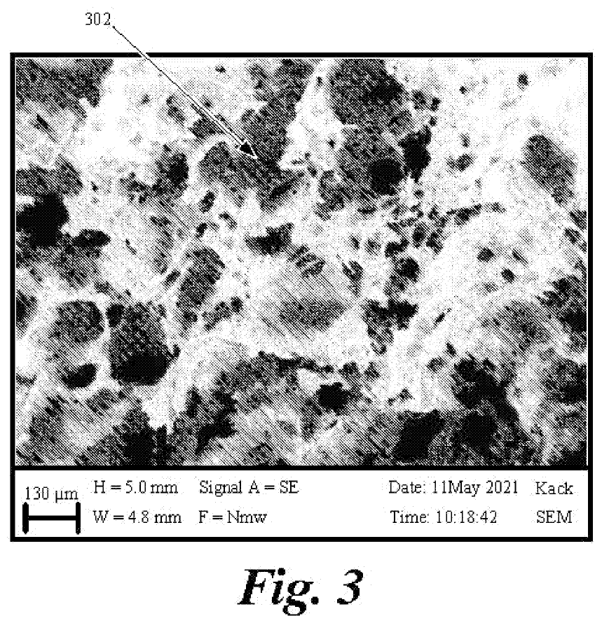

Referring to FIG. 3, an SEM micrograph of cross-sectioned ball 202 shows extensive network formation and high volume of air cells 302 enabled by an embodiment of the invention.

Referring back to FIG. 1, the form factors then undergo a cooling step 114.

In one embodiment, the form factors undergo an application step 116 whereby external flavors or seasonings are applied.

In another embodiment the form factors undergo a packaging step 118 whereby the form factors are packaged for storage, distribution, or other purposes.

Embodiments of the invention yield products that are unique in that they have an equivalent texture to commercial counterparts based on wheat, potato, rice, and corn, but provide superior nutrition. Referring to FIGS. 2A-2E, the dough can be formed and dried into a wide variety of form factors, including balls 202, sheets 204, flakes 206, croutons 208, and cones 210, all of which can possess varying expansion and texture and nutritional profile.

Embodiments of the invention yield products with textures ranging from the brittle crunchiness of a waffle cone to the layered crunchiness of a cracker and the expanded crunchiness of a crouton. These can be used as a substitute for commercially available products and ingredients, providing comparable flavor profiles and texture.

Properties of the dough of embodiments of the present invention include rheological and textural properties.

Expansion properties: The expansion ratio of the dried products is determined by measuring product dimensions with a caliper and calculating the square of the cross-sectional area of each piece and dividing that by the square of the cross-sectional area of the die used in forming the dough prior to drying. Piece density is measured by using the Rapeseed Displacement method. Apparent density is measured by measuring the mass of a 5 mL volume of ground and sieved (60-mesh sieve, 250 μm) sample. Porosity is accordingly calculated utilizing the difference between apparent and piece density divided by the apparent density. These measurements are all indicators of the amount of expansion each sample experiences and can be correlated to differences in texture.

The measured textural properties of the snack foods of embodiments of the present invention include hardness, crispness, crunchiness, stiffness.

Texture analysis is performed using a texturometer, such as a TA-XT2 texture analyzer. Prior to texture analysis, samples from each treatment are equilibrated in a desiccator with a saturated potassium acetate solution (aw<0.25) until reaching constant mass. Tests are performed (N=10) with a 25-mm compression probe with a pre- and post-test speed of 1 mm/s and a test speed of 0.5 mm/s, to 50% strain. Hardness is calculated by peak force (N), crispness by number of peaks, crunchiness by average force between peaks (N), Young's modulus by stress divided by strain (MPa).

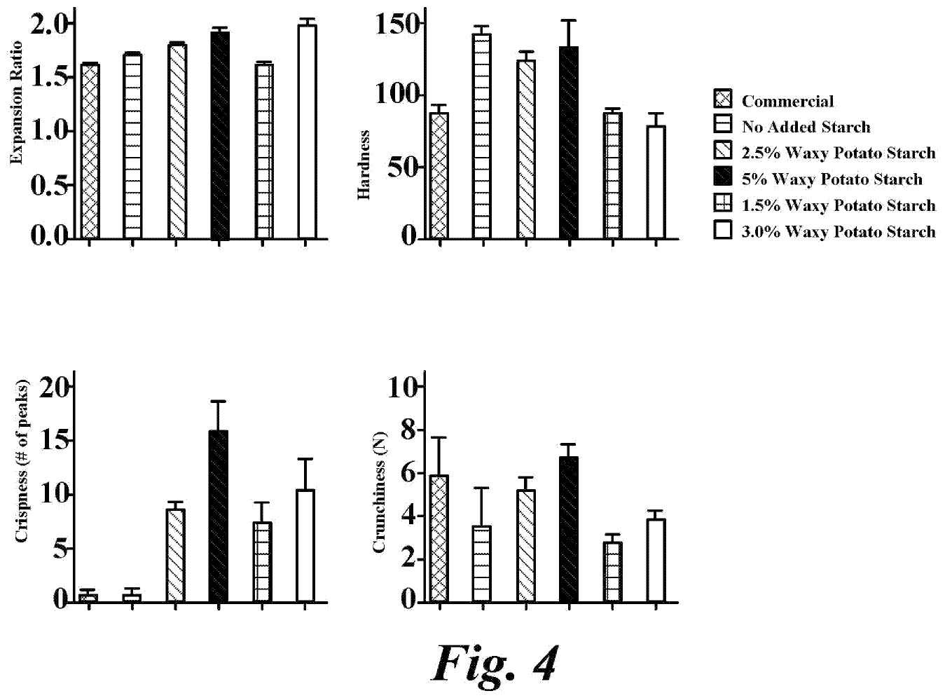

For example, FIG. 4 shows a graph comparing the expansion ratio and texture between ball 202 form factors of the embodiment produced by commercial convection (control) and five formulations under VMD (no added starch, 2.5 & 5.0% waxy potato, 1.5 & 3.0% waxy corn starch). Expansion ratio increased with starch addition, with higher levels of starch inducing more expansion. Hardness, the peak force exerted during chewing, was reduced closer to the level of the control upon the addition of waxy starches. Crispness, the incremental and progressive fracture of foods, was greatly enhanced with starch addition. Crunchiness, the average force exerted during chewing, varied but remained lower than the control, excluding 5.0% waxy potato starch.

One embodiment of the snack foods of the present invention has a hardness under 150 Newtons, crispness above 3 peaks, and crunchiness below 10 Newtons.

### Example I

The example below illustrates the ingredients and their relative amounts that are used to make an embodiment of the dough and snack food of the present invention.

In this embodiment, water and oil are added to the dry ingredients to make a dough. The resultant dough is comprised of 53.5% added water. 0.4% oil, 38.0% legume flour, 2.3% food starch, 1.8% hydrocolloids, 0.2% salt, and 3.9% textured proteins. The dough is formed and baked until dry. Additional oil and seasonings may be topically applied to enhance flavor profile.

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. An extruder is used to form and cut the dough into sheets of approximately 31×38 mm with a thickness between 2-3 mm. The form factors are placed onto stainless steel full baking sheets and baked either in a batch convection oven or tunnel oven until dry. The resulting crunchy pieces can be used as is or coated in oil and sweet or savory seasonings.

### Example II

The example below illustrates the ingredients and their relative amounts that are used to make an embodiment of the dough and snack food of the present invention.

In this embodiment, water and oil are added to the dry ingredients to make a dough. The resultant dough is comprised of 54.2% added water, 0.4% oil, 2.3% food starch, 1.8% hydrocolloids, 0.2% salt, and 41.0% textured proteins. The dough is formed and baked until dry. Additional oil and seasonings may be topically applied to enhance flavor profile.

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. An extruder is used to form and cut the dough into sheets of approximately 31×38 mm with a thickness between 2-3 mm. The form factors are placed onto stainless steel full baking sheets and baked either in a batch convection oven or tunnel oven until dry. The resulting crunchy pieces can be used as is or coated in oil and sweet or savory seasonings.

### Example III

The example below illustrates the ingredients and their relative amounts that are used to make embodiments of the dough and snack food of the present invention.

In this embodiment, water and oil are added to the dry ingredients to make a dough. The resultant dough is comprised of 53.2% added water, 0.4% oil, 9.8% legume flour, 2.3% food starch, 14.3% fiber powder, 0.4% hydrocolloids, 0.2% salt, and 19.3% textured proteins. The dough is formed and baked until dry. Additional oil and seasonings may be topically applied to enhance flavor profile.

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. An extruder is used to form and cut the dough into sheets of approximately 31×38 mm with a thickness between 2-3 mm. The form factors are placed onto stainless steel full baking sheets and baked either in a batch convection oven or tunnel oven until dry. The resulting crunchy pieces can be used as is or coated in oil and sweet or savory seasonings.

### Example IV

The example below illustrates the ingredients and their relative amounts that are used to make embodiments of the dough and snack food of the present invention.

In this embodiment, water and oil are added to the dry ingredients to make a dough. The resultant dough is comprised of 53.2% added water, 0.4% oil, 3.3% legume flour, 2.3% food starch, 14.3% fiber powder, 7.0% hydrocolloids, 0.2% salt, and 19.3% textured proteins. The dough is formed and baked until dry. Additional oil and seasonings may be topically applied to enhance flavor profile.

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. An extruder is used to form and cut the dough into sheets of approximately 31×38 mm with a thickness between 2-3 mm. The form factors are placed onto stainless steel full baking sheets and baked either in a batch convection oven or tunnel oven until dry. The resulting crunchy pieces can be used as is or coated in oil and sweet or savory seasonings.

### Example V

This example below illustrates the ingredients and their relative amounts that are used to make embodiments of the dough and snack food of the present invention.

In another embodiment, water, oil, and flavors are added to the dry ingredients to make a dough. The resultant dough is comprised of 48.1% added water, 0.5% oil, 2.4% flavors, 1.4% food starch, 1.8% sweeteners, 2.0% hydrocolloids, 0.2% salts, and 43.9% textured proteins (wet basis). The dough is formed and baked until dry. Additional oil and seasonings may be topically used to enhance flavor profile.

The nutritional profile for the snack food in this example is shown in Table 2, below.

TABLE 3
Nutritional profile for a snack food described
in example V (approximate per 100 g).

| Calories | 398 | |
|---|---|---|
| Total Fat | 8.9 | g |
| Saturated Fat | 1.0 | g |
| Trans Fat | 0.0 | g |
| Cholesterol | 0.0 | mg |
| Sodium | 760.5 | mg |
| Carbohydrate | 33.3 | g |
| Fiber | 10.4 | g |
| Sugar | 7.8 | g |
| Added Sugar | 2.8 | g |
| Protein | 50.5 | g |

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. The dough is either extruded into long strips of approximately 38 mm width or into small cylinders with an extruder. The form factors are placed onto stainless steel full baking sheets and baked either in a batch convection oven or tunnel oven until dry. If strips, the dried product is pulverized into small pieces. All form factors are coated in oil and dried fruit powders.

### Example VI

The example below illustrates the ingredients and their relative amounts that are used to make embodiments of the dough and snack food of the present invention.

In this embodiment, water and oil are added to the dry ingredients to make a dough. The resultant dough is comprised of 53.2% added water, 0.4% oil, 8.5% legume flour, 2.3% food starch, 14.3% fiber powder, 1.8% hydrocolloids, 0.2% salt, and 19.3% textured proteins (wet basis). This dough is formed and baked until dry. Additional oil and seasonings may be topically used to enhance flavor profile.

The nutritional profile for the snack food in this example is shown in Table 3, below.

TABLE 4
Nutritional profile for a snack food described
in Example VI (approximate per 100 g).

| Calories | 291 | |
|---|---|---|
| Total Fat | 4.7 | g |
| Saturated Fat | 0.5 | g |
| Trans Fat | 0.0 | g |
| Cholesterol | 0.0 | mg |
| Sodium | 748.5 | mg |
| Carbohydrate | 54.7 | g |
| Fiber | 32.9 | g |
| Sugar | 2.5 | g |
| Added Sugar | 0.0 | g |
| Protein | 31.7 | g |

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. An extruder is used to form and cut the dough into sheets of approximately 31×38 mm with a thickness between 2-3 mm. The form factors are placed onto stainless steel full baking sheets and baked either in a batch convection oven or tunnel oven until dry. The resulting crunchy pieces can be used as is or coated in oil and sweet or savory seasonings.

### Example VII

The example below illustrates the ingredients and their relative amounts that are used to make embodiments of the dough and snack food of the present invention.

In this embodiment, water and oil are added to the dry ingredients to make a dough. The resultant dough is comprised of 51.0% added water, 0.4% oil, 16.9% legume flour, 1.2% food starch, 26.3% fiber powder, 1.8% hydrocolloids, 0.8% salt, and 1.6% textured proteins. The dough is formed and baked until dry. Additional oil and seasonings may be topically applied to enhance flavor profile.

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. An extruder is used to form and cut the dough into sheets of approximately 31×38 mm with a thickness between 2-3 mm. The form factors are placed onto stainless steel full baking sheets and baked either in a batch convection oven or tunnel oven until dry. The resulting crunchy pieces can be used as is or coated in oil and sweet or savory seasonings.

### Example VIII

The example below illustrates the ingredients and their relative amounts that are used to make embodiments of the dough and snack food of the present invention.

In this embodiment, water and oil are added to the dry ingredients to make a dough. The resultant dough is comprised of 53.0% added water, 0.4% oil, 8.3% legume flour, 2.2% food starch, 12.9% fiber powder, 1.6% sweetener, 1.7% hydrocolloids, 0.2% salt, and 18.7% textured proteins (wet basis). This dough is formed and baked until dry. Additional oil and seasonings may be topically used to enhance flavor profile.

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. The dough is either extruded into long strips of approximately 38 mm width or into small cylinders with an extruder. The form factors are placed onto stainless steel full baking sheets and baked either in a batch convection oven or tunnel oven until dry. If strips, the dried product is pulverized into small pieces.

All form factors are coated in oil and sweet seasoning.

### Example IX

The example below illustrates the ingredients and their relative amounts that are used to make embodiments of the dough and snack food of the present invention.

In this embodiment, water and oil are added to the dry ingredients to make a dough. The resultant dough is comprised of 55.7% added water, 0.4% oil, 12.8% legume flour, 2.3% food starch, 5.6% fiber powder, 1.7% hydrocolloids, 0.2% salt, and 21.4% textured proteins (wet basis). This dough is formed and baked until dry. Additional oil and seasonings may be topically used to enhance flavor profile.

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. An extruder is used to form and cut the dough into sheets of approximately 31×38 mm with a thickness between 2-3 mm. The form factors are placed onto stainless steel full baking sheets and baked either in a batch convection oven or tunnel oven until dry. The resulting crunchy pieces can be used as is or coated in oil and sweet or savory seasonings.

### Example X

The example below illustrates the ingredients and their relative amounts that are used to make embodiments of the dough and snack food of the present invention.

In this embodiment, water, oil, and flavors are added to the dry ingredients to make a dough. The resultant dough is comprised of 47.7% added water, 0.5% oil, 2.2% flavors, 1.3% food starch, 1.8% sweeteners, 1.9% hydrocolloids, 0.2% salt, 19.1% native legume protein, and 25.2% textured proteins (wet basis). The dough is formed and baked until dry. Additional oil and seasonings may be topically used to enhance flavor profile.

In this embodiment, the dry ingredients are combined in a ribbon blender until homogeneous. The liquid ingredients are added and mixed for an additional 3-5 minutes. The resulting dough is either allowed to sit at room temperature for 30 minutes or refrigerated overnight. The dough is either extruded into long strips of approximately 38 mm width or into small cylinders with an extruder. The form factors are placed onto stainless steel full baking sheets and baked either in a batch convection oven or tunnel oven until dry. If strips, the dried product is pulverized into small pieces. All form factors are coated in oil and dried fruit powders.

### Example XI

The example below illustrates the ingredients and their relative amounts that are used to make embodiments of the dough and snack food of the present invention.

In this embodiment, water, butter, and oil are added to the dry ingredients to make a dough. The resultant dough is comprised of 8.3% added water, 5.2% oil, 18.7% legume flour, 2.3% food starch, 6.7% fiber powder, 0.6% hydrocolloids, 0.4% salt, and 13.1% textured proteins, 0.6% natural flavors, 1.1% leaveners, 26.3% sugar, and 16.6% butter (wet basis). This dough is formed and baked until dry. Additional toppings may be added to enhance the flavor profile.

In this embodiment, the butter and sugar are combined in a ribbon blender, followed by addition of the remaining dry ingredients. The liquid ingredients are added and mixed for an additional 3-5 minutes. The resulting dough is either allowed to sit at room temperature for 15 minutes or refrigerated overnight. An extruder or wire cut depositor is used to form and cut the dough into circles 13-100 mm in diameter with a thickness between 4-25 mm. The form factors are placed onto either stainless steel full baking sheets and baked in a batch convection oven or onto a belt and baked in a tunnel oven until dry. Toppings may be added prior to the bake. Toppings can also be added after the baking process.

### Example XII

The example below illustrates the ingredients and their relative amounts that are used to make embodiments of the dough and snack food of the present invention.

In this embodiment, water, butter, and oil are added to the dry ingredients to make a dough. The resultant dough is comprised of 8.4% added water, 5.8% oil, 7.2% legume flour, 1.6% food starch, 3.1% fiber powder, 0.5% hydrocolloids, 0.2% salt, and 15.8% textured proteins, 0.5% natural flavors, 1.0% flavor extracts, 1.0% leaveners, 22.1% sugar, 4.8% cocoa powder, 14.4% chocolate chips, and 13.7% butter (wet basis). This dough is formed and baked until dry. Additional toppings may be added to enhance the flavor profile.

In this embodiment, the butter and sugar are combined in a ribbon blender, followed by addition of the remaining dry ingredients. The liquid ingredients are added and mixed for an additional 3-5 minutes. The resulting dough is either allowed to sit at room temperature for 15 minutes or refrigerated overnight. An extruder or wire cut depositor is used to form and cut the dough into circles 13-100 mm in diameter with a thickness between 4-25 mm. The form factors are placed onto either stainless steel full baking sheets and baked in a batch convection oven or onto a belt and baked in a tunnel oven until dry. Toppings may be added prior to the bake. Toppings can also be added after the baking process.

### Example XIII

The example below illustrates the ingredients and their relative amounts that are used to make embodiments of the dough and snack food of the present invention.

In this embodiment, water, butter, and oil are added to the dry ingredients to make a dough. The resultant dough is comprised of 8.0% added water, 1.1% oil, 9.6% legume flour, 2.2% food starch, 27.3% fiber powder, 0.6% hydrocolloids, 0.4% salt, and 12.8% textured proteins, 0.6% natural flavors, 1.1% leaveners, 11.8% sugar, 8.2% sugar alcohols, 0.1% high intensity sweetener, and 16.3% butter (wet basis). This dough is formed and baked until dry. Additional toppings may be added to enhance the flavor profile.

In this embodiment, the butter and sugar are combined in a ribbon blender, followed by addition of the remaining dry ingredients. The liquid ingredients are added and mixed for an additional 3-5 minutes. The resulting dough is either allowed to sit at room temperature for 15 minutes or refrigerated overnight. An extruder or wire cut depositor is used to form and cut the dough into circles 13-100 mm in diameter with a thickness between 4-25 mm. The form factors are placed onto either stainless steel full baking sheets and baked in a batch convection oven or onto a belt and baked in a tunnel oven until dry. Toppings may be added prior to the bake. Toppings can also be added after the baking process.

### Example XIV

The example below illustrates the ingredients and their relative amounts that are used to make embodiments of the dough and snack food of the present invention.

In this embodiment, water and oil are added to the dry ingredients to make a dough. The resultant dough is comprised of 17.5% added water, 8.3% oil, 23.2% legume flour, 3.2% food starch, 35.4% fiber powder, 1.1% hydrocolloids, 0.4% salt, and 11.1% textured proteins (wet basis). This dough is formed and baked until dry. Additional oil and seasonings may be topically used to enhance flavor profile.

In this embodiment, the dry ingredients are combined in a hopper until homogenous. The liquid ingredients are added and mixed for an additional 3-5 minutes. A sheeter equipped with rotary cutter molder is used to form and cut the dough into sheets of various length and width (dependent on application) with a thickness between 1-3 mm. The form factors are placed onto either stainless steel full baking sheets and baked in a batch convection oven or onto a belt and baked in a tunnel oven until dry. Seasoning may be topically applied prior to the bake. The resulting crunchy pieces can be used as is or coated in oil and sweet or savory seasonings.

### Example XV

The example below illustrates the ingredients and their relative amounts that are used to make embodiments of the dough and snack food of the present invention.

In this embodiment, water and oil are added to the dry ingredients to make a dough. The resultant dough is comprised of 22.2% added water, 7.3% oil, 20.1% legume flour, 2.9% food starch, 26.3% fiber powder, 1.0% hydrocolloids, 0.3% salt, and 12.1% textured proteins, and 8.0% grain powder (wet basis). This dough is formed and baked until dry. Additional oil and seasonings may be topically used to enhance flavor profile.

In this embodiment, the dry ingredients are combined in a hopper until homogenous. The liquid ingredients are added and mixed for an additional 3-5 minutes. A sheeter equipped with rotary cutter molder is used to form and cut the dough into sheets of various length and width (dependent on application) with a thickness between 1-3 mm. The form factors are placed onto either stainless steel full baking sheets and baked in a batch convection oven or onto a belt and baked in a tunnel oven until dry. Seasoning may be topically applied prior to the bake. The resulting crunchy pieces can be used as is or coated in oil and sweet or savory seasonings.

### Example XVI

The example below illustrates the ingredients and their relative amounts that are used to make embodiments of the dough and snack food of the present invention.

In this embodiment, water, butter, and oil are added to the dry ingredients to make a dough. The resultant dough is comprised of 11.9% added water, 3.3% oil, 7.6% legume flour, 2.2% food starch, 27.1% fiber powder, 0.5% hydrocolloids, 0.4% salt, and 12.4% textured proteins, 1.7% natural flavors, 1.1% leaveners, 18.3% sugar alcohols, 0.2% high intensity sweetener, and 24.7% nonnutritive fat (wet basis). This dough is formed and baked until dry. Additional toppings may be added to enhance the flavor profile.

In this embodiment, the butter and sugar are combined in a ribbon blender, followed by addition of the remaining dry ingredients. The liquid ingredients are added and mixed for an additional 3-5 minutes. The resulting dough is either allowed to sit at room temperature for 15 minutes or refrigerated overnight. An extruder or wire cut depositor is used to form and cut the dough into circles 13-100 mm in diameter with a thickness between 4-25 mm. The form factors are placed onto either stainless steel full baking sheets and baked in a batch convection oven or onto a belt and baked in a tunnel oven until dry. Toppings may be added prior to the bake. Toppings can also be added after the baking process.

### Example XVII

The example below illustrates the ingredients and their relative amounts that are used to make embodiments of the dough and snack food of the present invention.

In this embodiment, water, butter, and oil are added to the dry ingredients to make a dough. The resultant dough is comprised of 11.0% added water, 1.1% oil, 7.9% legume flour, 2.2% food starch, 9% fiber powder, 0.6% hydrocolloids, 0.3% salt, and 18.3% textured proteins, 1.7% natural flavors, 1.1% leaveners, 10.6% sugar, 8.6% sugar alcohols, 0.1% high intensity sweetener, 5.5% cocoa powder, 8.3% chocolate chips and 13.9% butter (wet basis). This dough is formed and baked until dry. Additional toppings may be added to enhance the flavor profile.

In this embodiment, the butter and sugar are combined in a ribbon blender, followed by addition of the remaining dry ingredients. The liquid ingredients are added and mixed for an additional 3-5 minutes. The resulting dough is either allowed to sit at room temperature for 15 minutes or refrigerated overnight. An extruder or wire cut depositor is used to form and cut the dough into circles 13-100 mm in diameter with a thickness between 4-25 mm. The form factors are placed onto either stainless steel full baking sheets and baked in a batch convection oven or onto a belt and baked in a tunnel oven until dry. Toppings may be added prior to the bake. Toppings can also be added after the baking process.

### Example XVIII

The example below illustrates the ingredients and their relative amounts that are used to make embodiments of the dough and snack food of the present invention.

In this embodiment, water and oil are added to the dry ingredients to make a dough. The resultant dough is comprised of 45.4% added water, 0.5% oil, 10.0% legume flour, 2.7% food starch, 15.0% fiber powder, 2.1% hydrocolloids, 0.2% salt, 22.5% textured proteins, and 1.5% leaveners (wet basis). This dough is formed and baked until dry. Additional oil and seasonings may be topically used to enhance flavor profile.

In this embodiment, the dry ingredients are combined in a hopper until homogenous. The liquid ingredients are added and mixed for an additional 3-5 minutes. A sheeter equipped with rotary cutter molder is used to form and cut the dough into sheets of various length and width (dependent on application) with a thickness between 1-3 mm. The form factors are placed onto either stainless steel full baking sheets and baked in a batch convection oven or onto a belt and baked in a tunnel oven until dry. Seasoning may be topically applied prior to the bake. The resulting crunchy pieces can be used as is or coated in oil and sweet or savory seasonings.

### Example XIX

The example below illustrates the ingredients and their relative amounts that are used to make embodiments of the dough and snack food of the present invention.

In this embodiment, water, butter, and oil are added to the dry ingredients to make a dough. The resultant dough is comprised of 11.1% butter, 10.3% legume flour, 2.2% food starch, 10.4% fiber powder, 0.6% salt, and 16.7% textured proteins, 5.6% legume protein, 0.6% natural flavors, 0.8% leaveners, 5.0% sugar, 15.5% sugar alcohols, 0.3% high intensity sweetener, 13.9% eggs, 7.21% humectants or sweetener syrup, (wet basis). This dough is formed and baked until dry. Additional toppings may be added to enhance the flavor profile.

In this embodiment, the butter and sugar are combined in a ribbon blender, followed by addition of the remaining dry ingredients. The liquid ingredients are added and mixed for an additional 3-5 minutes. The resulting dough is either allowed to sit at room temperature for 15 minutes or refrigerated overnight. An extruder or wire cut depositor is used to form and cut the dough into circles 13-100 mm in diameter with a thickness between 4-25 mm. The form factors are placed onto either stainless steel full baking sheets and baked in a batch convection oven or onto a belt and baked in a tunnel oven until dry. Toppings may be added prior to the bake. Toppings can also be added after the baking process.

### Example XX

The example below illustrates the ingredients and their relative amounts that are used to make embodiments of the dough and snack food of the present invention.

In this embodiment, water and oil are added to the dry ingredients to make a dough. The resultant dough is comprised of 39.6% added water, 0.5% oil, 32.1% legume flour, 22.1% fiber powder, 2.4% hydrocolloids, 1.1% salt, and 2.2% textured proteins (wet basis). This dough is formed and baked until dry. Additional oil and seasonings may be topically used to enhance flavor profile.

In this embodiment, the dry ingredients are combined in a ribbon blender until homogeneous. The liquid ingredients are added and mixed for an additional 3-5 minutes. The resulting dough is either allowed to sit at room temperature for 15 minutes or refrigerated overnight. An extruder is used to form and cut the dough into cubes of approximately 12.7 mm. The form factors are placed onto plastic trays and processed in a vacuum microwave drier until dry. The resulting crunchy pieces can be used as is or coated in oil and sweet or savory seasonings, or chocolate or confectionery coatings.

### Example XXI

The example below illustrates the ingredients and their relative amounts that are used to make embodiments of the dough and snack food of the present invention.

In this embodiment, water, butter, and oil are added to the dry ingredients to make a dough. The resultant dough is comprised of 8.3% added water, 5.1% oil, 20.3% legume flour, 2.2% food starch, 8.1% fiber powder, 0.4% salt, and 13.1% textured proteins, 0.9% natural flavors, 1.1% leaveners, 26.2% sugar, and 16.5% butter (wet basis). This dough is formed and baked until dry. Additional toppings may be added to enhance the flavor profile.

In this embodiment, the butter and sugar are combined in a ribbon blender, followed by addition of the remaining dry ingredients. The liquid ingredients are added and mixed for an additional 3-5 minutes. The resulting dough is either allowed to sit at room temperature for 15 minutes or refrigerated overnight. An extruder or wire cut depositor is used to form and cut the dough into circles 13-100 mm in diameter with a thickness between 4-25 mm. The form factors are placed onto either stainless steel full baking sheets and baked in a batch convection oven or onto a belt and baked in a tunnel oven until dry. Toppings may be added prior to the bake. Toppings can also be added after the baking process.

### Example XXII

The example below illustrates the ingredients and their relative amounts that are used to make embodiments of the dough and snack food of the present invention.

In this embodiment, water and oil are added to the dry ingredients to make a dough. The resultant dough is comprised of 31.9% added water, 10.6% oil, 10.2% fiber powder, and 47.3% textured proteins (wet basis). This dough is formed and baked until dry. Additional oil and seasonings may be topically used to enhance flavor profile.

In this embodiment, the dry ingredients are combined in a hopper until homogenous. The liquid ingredients are added and mixed for an additional 3-5 minutes. A sheeter equipped with rotary cutter molder is used to form and cut the dough into sheets of various length and width (dependent on application) with a thickness between 1-3 mm. The form factors are placed onto either stainless steel full baking sheets and baked in a batch convection oven or onto a belt and baked in a tunnel oven until dry. Seasoning may be topically applied prior to the bake. The resulting crunchy pieces can be used as is or coated in oil and sweet or savory seasonings.

### Example XXIII

The example below illustrates the ingredients and their relative amounts that are used to make embodiments of the dough and snack food of the present invention.

In this embodiment, water, butter, and oil are added to the dry ingredients to make a dough. The resultant dough is comprised of 8.3% added water, 2.2% oil, 15.6% legume flour, 1.7% food starch, 16.3% fiber powder, 0.7% salt, and 3.3% textured proteins, 2.0% flavor extracts, 19.5% sugar, 5.5% butter, 13.3% eggs, 1.3% hydrocolloids, 10.4% inclusions (wet basis). This dough is formed and baked until dry. Additional toppings may be added to enhance the flavor profile.

In this embodiment, the dry powdered ingredients are combined in a ribbon blender and homogenized, followed by incorporation of the butter. The liquid ingredients are added and mixed for an additional 3-5 minutes. The inclusions are added and incorporated into the resulting dough, which is allowed to sit at room temperature for 15 minutes or refrigerated overnight. An extruder is used to form and cut the dough into segments at least 250 mm long with a thickness between 50-76 mm. The form factors are placed onto either stainless steel full baking sheets and baked in a batch convection oven or onto a belt and baked in a tunnel oven until partially dry. The par-baked segments are then sliced lengthwise into segments of 13 mm and baked until dry. The resulting crunchy pieces can be used as is or coated in chocolate or confectionery coatings.

### Example XXIV

The example below illustrates the ingredients and their relative amounts that are used to make embodiments of the dough and snack food of the present invention.

In this embodiment, water and oil are added to the dry ingredients to make a dough. The resultant dough is comprised of 11.9% added water, 11.8% oil, 18.8% fiber powder, 6.5% textured proteins, 6.0% legume flour, 19.8% sweeteners, 1.4% baking powder, 0.5% salt, 4.3% dried fruit, 0.4% citric acid, 0.7% hydrocolloids, 16.6% eggs, and 1.3% natural flavors (wet basis). This dough is formed and baked for 15 minutes.

In this embodiment, the dry ingredients are combined in a hopper until homogenous. The liquid ingredients are added and mixed for an additional 2-5 minutes. The dough is flowable and is deposited into metal molds in the desired shape and baked in a convection oven until the target moisture content is reached. The resulting soft baked good can be used as is or topped with additional ingredients to enhance flavor profile.

### Example XXV

The example below illustrates the ingredients and their relative amounts that are used to make embodiments of the dough and snack food of the present invention.

In this embodiment, water and oil are added to the dry ingredients to make a dough. The resultant dough is comprised of 11.9% added water, 11.8% oil, 18.8% fiber powder, 6.5% textured proteins, 6.0% legume flour, 19.8% sweeteners, 1.4% baking powder, 0.5% salt, 4.3% dried fruit, 0.4% citric acid, 0.7% hydrocolloids, 16.6% eggs, and 1.3% natural flavors (wet basis). This dough is formed and baked for 15 minutes.

In this embodiment, the dry ingredients are combined in a hopper until homogenous. The dry blend is then distributed into packaging to prevent moisture absorption during transportation and storage.

### Example XXVI

The example below illustrates the ingredients and their relative amounts that are used to make embodiments of the dough and snack food of the present invention.

In this embodiment, the liquid ingredients are added to the dry ingredients to make a dough. The resultant dough is comprised of 28.4% added water, 15.7% whey protein, 10.0% legume protein, 9.3% sweeteners, 7.6% cocoa powder, 7.0% humectants, 5.1% oil, 3.8% legume flour, 5.2% textured proteins, 2.3% natural flavors, 1.8% inclusions, 1.3% salt, 1.1% hydrocolloids, 0.9% emulsifier, 0.4% baking powder, and 0.1% yeast extract (wet basis). This dough is formed and baked.

In this embodiment, the dry ingredients are combined in a hopper until homogenous. The emulsifier is combined with the water and added into the dry ingredients and mixed. The oil and humectants are added and mixed until a dough/batter is formed. The dough is then placed into molds, extruded into individual shapes, or deposited onto baking trays and baked in a convection oven for 10-15 minutes.

### Example XXVII

The example below illustrates an embodiment of the present invention.

In this embodiment, the textured protein is milled through a hammer mill to a particle size where approximately 75% of the product runs through a 60-mesh (0.25 mm) screen and approximately 30% runs through a 120-mesh (0.125 mm) screen. The protein powder is then distributed into packaging to prevent moisture absorption during transportation and storage. In other embodiments the particle size could be as small as 0.05 mm or as large as 0.9 mm.

### Example XXVIII

The example below illustrates the ingredients and their relative amounts that are used to make embodiments of the dough and snack food of the present invention.

In this embodiment, the liquid ingredients are added to the dry ingredients to make a dough. The resultant dough is comprised of 25.0% sweetener, 19.0% legume protein, 13.3% oil, 12.7% whey protein, 12.0% humectant, 4.6% added water, 4.2% fiber powder, 2.9% inclusions, 2.6% natural flavors, 1.9% textured proteins, 0.9% baking powder, 0.4% salt, 0.4% emulsifier, and 0.1% yeast extract (wet basis). This dough is formed and baked. Additional toppings may be used to enhance flavor profile.

In this embodiment, the oil, fiber powder, and sweeteners are mixed together until a paste is formed, followed by the water and emulsifier, then the humectants and natural flavors. The remaining dry ingredients are added and mixed until a dough/batter is formed. The dough is then formed into discs between 20-90 mm in diameter and 2-8 mm in height, then baked in a convection oven for 5-10 minutes. Toppings may be added prior to baking. Toppings can also be added after the baking process.

### Example XXIX

The example below illustrates the ingredients and their relative amounts that are used to make embodiments of the dough and snack food of the present invention.

In this embodiment, the liquid ingredients are added to the dry ingredients to make a dough. The resultant dough is comprised of 27.2% legume protein, 26.5% sweetener, 13.6% humectants, 15.1% oil, 5.9% added water, 4.4% textured proteins, 3.0% fiber powder, 1.2% emulsifier, 0.9% baking powder, 0.8% natural flavors, 0.6% hydrocolloids, 0.4% cinnamon powder, and 0.4% salt (wet basis). This dough is formed and baked. Additional toppings may be used to enhance flavor profile.

In this embodiment, the oil and sweeteners are mixed together until a paste is formed, followed by the water and emulsifier, then the humectants and natural flavors. The remaining dry ingredients are added and mixed until a dough/batter is formed. The dough is then formed into discs between 20-90 mm in diameter and 2-8 mm in height, then baked in a convection oven for 5-10 minutes. Toppings may be added prior to baking. Toppings can also be added after the baking process.

### Nutritional Properties and Textural Comparison:

Table 4, below, demonstrates some of the nutritional profiles for example formulations of a crunchy snack (fiber, protein, and fiber+protein forward formulations) according to embodiments of the present invention. It shows the complete nutritional profiles for different products.

TABLE 5
Nutritional Profile Examples

| | | High | | High Fiber + |
|---|---|---|---|---|
| Composition per 100 g | Standard | Protein | High Fiber | Protein |
| (Dry Basis) | Combi | Combi | Combi | Combi |
| Calories (cal) | 358 | 373 | 369 | 370 |
| Calories from fat (cal) | 43.7 | 32.5 | 30.4 | 39.9 |
| Total carbohydrate (g) | 66.7 | 58.4 | 76.0 | 51.2 |
| Fat (g) | 5.6 | 4.4 | 4.3 | 5.8 |
| Saturated fatty acid (g) | 0.698 | 0.585 | 0.511 | 0.71 |
| Cholesterol (mg) | <1.07 | <1.03 | <1.03 | <1.03 |
| Total dietary fiber (g) | 22.5 | 29.6 | 39.6 | 19.6 |
| Non-inulin fiber | 16.6 | 10.6 | 14.1 | 12.8 |
| (g/100 g) | | | | |
| Inulin (g) | 5.9 | 19.0 | 25.5 | 6.79 |
| Total sugar (g) | 3.5 | 3.4 | 4.5 | 3.0 |
| Protein (g) | 20.1 | 32.1 | 15.6 | 37.6 |
| Calcium (mg) | 121.67 | 84.3 | 101.3 | 99.7 |
| Iron (mg) | 5.37 | 7.6 | 4.2 | 8.8 |
| Potassium (mg) | 973.33 | 703.3 | 763.3 | 853.3 |
| Sodium (mg) | 2366.7 | 1723.3 | 1256.7 | 1773.3 |
| Vitamin D (mcg) | <0.21 | <0.209 | <0.208 | <.209 |
| Ash (g) | 8.34 | 5.86 | 5.05 | 6.69 |

Table 5, below, shows a textural comparison of balls 202 produced according to embodiments of the present invention with base, high fiber, high protein, and high fiber & protein doughs by VMD and combi drying

TABLE 6
Textural Comparison

| | | | |
|---|---|---|---|
| | Crispness | | Young's |
| Hardness | (# of | Crunchiness | Modulus |
| (N) | peaks) | (N) | (MPa) |

Standard

| | | | | |
|---|---|---|---|---|
| VMD | 103.91 | 8.00 | 3.88 | 1.62 |
| Combi | 79.97 | 3.70 | 4.61 | 1.38 |

High Protein

| | | | | |
|---|---|---|---|---|
| VMD | 84.48 | 2.85 | 3.84 | 1.97 |
| Combi | 68.62 | 3.00 | 5.55 | 2.17 |

High Fiber

| | | | | |
|---|---|---|---|---|
| VMD | 112.77 | 11.67 | 8.67 | 2.20 |
| Combi | 83.62 | 4.33 | 6.01 | 2.74 |

High Protein
& Fiber

| | | | | |
|---|---|---|---|---|
| VMD | 78.88 | 15.07 | 7.14 | 1.85 |
| Combi | 72.73 | 4.43 | 4.82 | 2.08 |

Insofar as the description above and the accompanying drawing disclose any additional subject matter that is not within the scope of the single claim below, the inventions are not dedicated to the public and the right to file one or more applications to claim such additional inventions is reserved.

Although the present invention has been described in considerable detail with reference to certain preferred versions thereof, other versions are possible. Therefore, in the spirit and scope of the appended claims should not be limited to the description of the preferred versions contained herein.

What is claimed is:

1. A dry mix for baked goods comprising:
textured pulse protein powder;
legume flour;
sweeteners;
salt.

2. The dry mix of claim 1 wherein the textured pulse protein powder is a milled powder.

3. The dry mix of claim 2 wherein the texted pulse protein powder is a hammer milled powder.

4. A dry mix for a gluten-free flour replacement comprising:
textured pulse protein powder;
legume flour.

5. The dry mix of claim 4 wherein the textured pulse protein powder is a milled powder.

6. The dry mix of claim 5 wherein the texted pulse protein powder is a hammer milled powder.

7. A dry mix for a leavener comprising:
textured pulse protein powder;
hydrocolloids.

8. The dry mix of claim 7 wherein the textured pulse protein powder is created by milling textured proteins into a powder.

9. The dry mix of claim 8 wherein the texted pulse protein powder is a hammer milled powder.

10. The dry mix of claim 7 wherein the hydrocolloid is xanthan gum.

11. A method of creating a pulse protein powder, said method comprising the steps of:
(i) milling textured pulse protein
(ii) repeat said milling process until the resultant powder has a particle size between 0.05 mm and 0.9 mm.

12. The method of claim 11 wherein the particle size of the resultant powder is such that approximately 75% of the product runs through a 60-mesh (0.25 mm) screen and approximately 30% runs through a 120-mesh (0.125 mm) screen.

13. The method of claim 11 wherein the method of milling is selected from the group of hammer, jet, colloid, corundum, air classifier, ball, pin, crushers, shredders, and granulators.

14. The method of claim 11 wherein the method of milling is hammer milling.

15. A method for making a non-crunchy food, said method comprising the steps of:
(i) homogenization of dry feed powders, including textured pulse protein powder;
(ii) mixing and hydration of dry feed powders with water and fat to form a dough;
(iii) forming of said dough into a form factor;
(iv) drying and expansion; and
(v) cooling into an aerated matrix.
